(19) United States
(12) Patent Application Publication
(10) Pub. No.: US 2010/0209659 A1
(43) Pub. Date: Aug. 19, 2010

(54) CARBON-CARBON COMPOSITE

(76) Inventor: Bojan Obrad Boskovic, Cambridge (GB)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/667,426

(22) PCT Filed: Jul. 3, 2008
(86) PCT No.: PCT/GB2008/002290

§ 371 Date: Apr. 29, 2010

(30) Foreign Application Priority Data
Jul. 3, 2007 (GB) 0712820.0

(51) Int. Cl. B32B 5/12; B29C 43/00; D01F 9/12

(52) U.S. Cl. 428/113; 428/292.1; 264/152; 264/405; 423/447.1; 977/742

(57) ABSTRACT

The invention relates to a preform for a carbon-carbon composite. The preform comprises a consolidated stack of two or more two-dimensional fibre layers having between the layers a carbon nanotube and/or nanofibre network. Carbon-carbon composites made from the preform have application in a wide range of fields, e.g. as friction discs in braking systems, especially aircraft braking systems.

This invention relates to preforms for carbon-carbon composites containing carbon nanotubes and/or nanofibres, carbon-carbon composites containing carbon nanotubes and/or nanofibres, articles made of such composites and methods of producing such preforms, composites and articles made therefrom.

Carbon-carbon composite materials are well known for their mechanical properties such as good wear resistance and heat absorption, which make them suitable for a number of applications, e.g. friction discs and heat packs in aircraft braking systems.

Carbon-carbon composite materials and the like are usually fabricated by making a fibre preform, before densifying the preform with a matrix of composite material. A fibre preform can be densified with its matrix by a liquid process and/or a gaseous process. In the liquid process, the preform is impregnated with a liquid composition containing a precursor (typically a resin) of the matrix. A subsequent heat treatment is employed to transform the precursor so as to obtain the desired matrix material. The gaseous process, which is also well known, is known as chemical vapour infiltration (CVI). During CVI, the preform is located in an oven into which gas is allowed to enter. The gas contains at least one component forming a gaseous precursor for the matrix material.

Carbon nanotubes and less crystalline carbon nanofibres have attracted attention with their fascinating properties including excellent mechanical strength, electrical and thermal conductivity. Carbon nanotubes produced in arc-discharge were described by lijima in 1991 [Nature, 354, 1991, 56]. Since then other carbon nanotube synthesis methods have been developed, such as laser vaporisation, electron beam, catalytic pyrolysis, and chemical vapour deposition (CVD). Carbon nanofibres (carbon filaments) and methods for their manufacture were described in the 1950s and developed in the 1970s.

Carbon nanotubes and nanofibres have been used as reinforcement in carbon-carbon (C—C) composites and ceramic matrix composite materials, e.g. as shown in U.S. Pat. No. 4,663,230, and have been grown on a variety of substrates through the decomposition of a gas feedstock over a metal catalyst dispersed on a surface or within a porous substrate (see, for example, WO2004/078649).

U.S. patent application Ser. No. 11/077,005, published as US 2005/0176329, to Olry et al discloses a method for growing carbon nanotubes in a three-dimensional preform or on a carbon fibre fabric that is assembled and then bonded by needling to provide a consolidated three-dimensional fibre structure. The carbon nanotubes are grown on the carbon fibres in the fibre structure using metal salts which must be decomposed and then reduced. Carbon nanotubes are present to give additional density in the three-dimensional fibre structure and dissect voids, thereby reducing subsequent CVI processing time.

While U.S. patent application Ser. No. 11/077,005 shows improvements in wear compared with composites without nanotubes, it is also known that three-dimensional composites of the type disclosed in U.S. Ser. No. 11/077,005 have higher wear rates than two-dimensional composites. Moreover, needling can cause damage to continuous fibres, thereby reducing composite strength.

Accordingly, it is a non-exclusive object of the invention to provide an improved preform and/or an improved carbon-carbon composite article.

In addition, it is a non-exclusive object of the invention to provide an improved carbon-carbon composite material comprising nanotubes and/or nanofibres so as to realise the advantages of reduced CVI processing time.

It is a further non-exclusive object of the invention to provide a method of manufacture of the improved preform for a carbon-carbon composite.

It is another non-exclusive object of the invention to provide a method of manufacture of the improved carbon-carbon composite material.

According to a first aspect of the invention there is provided a preform for a carbon-carbon composite, the preform comprising a plurality of layers of fibres and a plurality of nanotubes and/or nanofibres wherein at least some of the nanotubes and/or nanofibres have proximal ends extending from a single location between and spaced from fibres of the preform.

According to another aspect of the invention there is provided a consolidated preform for a carbon-carbon composite comprising a stack of two or more two-dimensional fibre layers having between the layers and preferably between the fibres within the layers a carbon nanotube and/or nanofibre network.

Preferably, the carbon nanotube and/or nanofibre network provides a physical bond, e.g. a mechanical interlock, to at least partially hold together a first layer of the stack and a second layer of the stack.

The mechanical interlock may be sufficient to consolidate the preform.

The fibres within the two-dimensional fibre layers may comprise refractory fibres such as carbon fibres or ceramic fibres. The fibres may comprise carbon nanotubes and/or nanofibres.

The two-dimensional fibre layers may be provided by sheets or appropriately sized portions cut from one or more sheets.

The carbon nanotubes and/or nanofibres may provide a mechanical interlock to hold neighbouring (e.g. succeeding) layers together.

The network may be substantially continuous throughout the stack. Alternatively, the network may comprise a plurality of distinct sub-networks.

The network may comprise carbon nanotubes and/or nanofibres having a length longer than the width of the fibres within the two-dimensional layers.

The network may comprise nanotube and/or nanofibre clusters, bundles, ropes and yarns.

The nanotube and/or nanofibre network or clusters, bundles, ropes and yarns may comprise interconnected three-dimensional entangled agglomerates, e.g. spherical or approximately spherical agglomerates.

The mechanical interlock may be provided by nanotubes, nanofibres or by groups such as clusters and bundles of non-directional nanotubes and/or nanofibres or ropes and yarns comprising an assembly of nanotubes and/or nanofibres in a plurality of directions or in a preferred direction. A preferred direction for nanotube and/or nanofibre growth may be out of, e.g. substantially perpendicular to, the fibre-containing plane of at least one layer within the stack.

Preferably, at least some of the nanotubes, nanofibres or clusters, bundles, ropes or yarns of nanotubes and/or nanofibres providing the mechanical interlock may be present in spaces between, but not attached, e.g. chemically bonded to or grown from, the fibres.

For example, a minority, i.e. less than 50%, preferably between 0 and 30%, more preferably 0 and 20%, of the carbon nanotubes making up the network may be chemically bonded to fibres within the stack.

Alternatively, at least some of the carbon nanotubes and/or nanofibres making up the network may be attached, e.g. chemically bonded, to fibres within the layers of the stack. For example, a majority, preferably at least 70% or 80%, of the carbon nanotubes making up the network may be chemically bonded to fibres within the stack.

The consolidation or mechanical interlock may be provided by at least one of:
the entanglement between one or more nanotubes at least partially located in the or a first layer of the stack with one or more nanotubes at least partially located in the or a second layer of the stack;
the entanglement between one or more nanotubes attached, e.g. chemically bonded, to one or more fibres in the or a first layer of the stack with one or more fibres in the or a second layer of the stack;
the entanglement between one or more nanotubes attached, e.g. chemically bonded, to one or more fibres in the or a second layer of the stack with one or more fibres in the first layer of the stack; and
the entanglement between one or more nanotubes attached, e.g. chemically bonded, to one or more fibres in the or a first layer of the stack with one or more nanotubes attached, e.g. chemically bonded, to one or more fibres in the or a second layer of the stack.

A proportion of the carbon nanotubes and/or nanofibres may be preferentially oriented. For example, they may be preferentially oriented in directions out of, e.g. substantially perpendicular to, the fibre-containing plane of at least one layer within the stack.

The two-dimensional fibre layers may comprise a carbon fibre fabric or felt. An example of a suitable fabric is a non-woven carbon fibre fabric comprising a staple layer needled to continuous fibre tows as disclosed in the applicant's British Patent GB 2,012,671, the entire disclosure of which is incorporated herein by reference.

In a second aspect of the invention there is provided a method of manufacture of a preform for a carbon-carbon composite, the method comprising:
providing a sheet comprising a two-dimensional fibre layer;
cutting the sheet into appropriately sized portions;
arranging the portions into a stack to provide at least a pair of two-dimensional fibre layers;
compressing the stack to a preferred fibre volume; and
forming carbon nanotubes within the stack to at least partially consolidate the layers either before or after said compressing step.

The two-dimensional fibre layers may comprise a carbon fabric or felt.

The portions may be arranged into the stack on a first jig plate, a second jig plate being placed on top of the stack, the stack being compressed between the first and second jig plates.

The stack may comprise unfilled space, e.g. voids and pores, between the fibres in the layers and/or between the layers.

A carbon source for growing the carbon nanotubes and/or nanofibres may be provided.

The carbon source may be a hydrocarbon gas such as methane or natural gas; a carbon containing gas such as carbon monoxide or carbon dioxide; or any other carbon containing compound.

Formation of the carbon nanotubes and/or nanofibres may be promoted by using a catalyst, typically a metal catalyst.

At least some of the carbon nanotubes and/or nanofibres may be formed such that their proximal ends extend from a location between fibres of the perform.

The catalyst may provide sites for the growth of carbon nanotubes and/or nanofibres. Preferably, the sites may be located between the fibres in the layers and/or between the layers, e.g. in spaces such as voids and pores within the stack. Preferably, nanotube clusters and entangled agglomerates may grow out from and around said sites.

The metal catalyst may be a transition metal, preferably iron, nickel or cobalt, or a transition metal compound. Metal catalyst powders may be preferred.

Metal catalyst particles or agglomerations thereof may provide sites for the growth of nanotubes.

The metal catalyst may be provided in solution, e.g. as a powder dissolved in a solvent. The solvent may be an alcohol. Alternatively or additionally, the metal catalyst may be provided in the form of a dispersion, e.g. metal catalyst powder dispersed in an alcohol.

The method may comprise using a solution or dispersion of metal catalyst, e.g. metal catalyst powder, to impregnate the fibre layers with the metal catalyst. The stack of fibre layers may be held in the jig during impregnation.

Alternatively, the layers may be impregnated with the metal catalyst prior to being arranged into the stack.

In a further alternative one or more individual layers within the stack may be impregnated with the metal catalyst. For instance, one or more layers may not be impregnated with the catalyst. Alternatively, different catalysts may be used for different layers.

Following impregnation with a catalyst the method may comprise a drying step.

The method may comprise placing the stack in a furnace suitable for nanotube and/or nanofibre growth. When placed in the furnace, the stack may or may not be held in the jig.

According to another aspect of the invention, there is provided a method of manufacture of a preform for a carbon-carbon composite, the method comprising providing an unconsolidated stack of at least a pair of two-dimensional fibre layers and forming carbon nanotubes and/or nanofibres, whereby the carbon nanotubes and/or nanofibres consolidate the preform.

The two-dimensional fibre layers may be provided by sheets or appropriately-sized portions cut from the sheets.

The method may comprise compressing, e.g. in a jig, the unconsolidated stack to a preferred fibre volume. The compression of the unconsolidated stack may bring at least some of the fibres in successive layers into intimate contact.

The method may comprise providing a source of carbon and contacting carbon from the source with the stack to grow the carbon nanotubes and/or nanofibres.

The formation of the carbon nanotubes and/or nanofibres may be promoted by using a catalyst, typically a metal catalyst, e.g. a transition metal such as iron, nickel or cobalt, or a transition metal compound.

The metal catalyst may be provided in a solution or a dispersion. The metal catalyst may be dissolved or dispersed in an alcohol.

The method may comprise a drying step after the provision of the metal catalyst.

The method may further comprise placing the stack in a furnace suitable for nanotube and/or nanofibre growth.

In the methods of the invention, the nanotubes and/or nanofibres may be formed in situ in the stack. This results inter alia in formation of a proportion of the nanotubes and/or nanofibres in the direction approximately perpendicular to the plane of the fibre layers in the stack. The proportion of nanotubes and/or nanofibres formed in the direction largely perpendicular to the plane of the fibre layers may be increased by growth in an electric field such as that found in, e.g. generated by, plasma assisted CVD.

Alternatively or additionally, the nanotubes and/or nanofibres may be formed before cutting the sheet into appropriately sized portions or arranging the portions into a stack or compressing the stack.

According to another aspect of the invention there is provided a preform for a carbon-carbon composite comprising a stack of two or more two-dimensional fibre layers having carbon nanotubes and/or nanofibres present between layers in the stack, wherein the carbon nanotubes and/or nanofibres form a network which consolidates the preform.

Preferably, the carbon nanotubes and/or nanofibres are also present between fibres within the layers of the stack.

A further aspect of the invention provides a preform for a carbon-carbon composite comprising a fist component and a second component, wherein the first component comprises a stack of two or more two-dimensional fibre layers and the second component comprises a network of entangled nanotubes and/or nanofibres, e.g. carbon nanotubes and/or nanofibres, wherein the second component is present within voids and pores within the first component without being chemically bonded to the first component.

A method of manufacture of a carbon-carbon composite may comprise providing a preform as described herein and densifying the preform.

The preform may be densified using tar, pitch and/or liquid phase materials and/or by chemical vapour infiltration.

A carbon-carbon article may be formed from a preform and/or by a method as described herein.

The article may be a friction disc for an aircraft braking system.

The article may be a clutch or friction disc.

According to yet another aspect of the invention there is provided a method of making a component for a brake assembly, e.g. a brake disc for an aircraft, comprising a carbon-carbon composite, the method comprising the steps of:
dispersing catalyst particles within a three-dimensional structure; and
forming nanotubes at and extending from said particles.

The three-dimensional structure may comprise any preform as described and/or illustrated herein.

In this application, the word preform is used to refer to a structure which is subsequently impregnated with a matrix, e.g. carbon, to give a densified composite material.

By unconsolidated we mean that the layers in the stack have not been connected together, e.g. by needling, i.e. the stack may be readily altered or disassembled by the addition or removal of additional two-dimensional fibre layers.

The terms consolidated, consolidate and the like are to be construed accordingly. For example, the two-dimensional fibre layers within a consolidated preform are held together, e.g. by a carbon nanotube and/or nanofibre network, such that the stack may not be readily disassembled into its constituent layers.

The presence of carbon nanotubes and/or nanofibres between two-dimensional fibre layers may advantageously increase the interlaminar shear strength of a preform (and hence a composite) according to the invention.

Advantageously, performs according to the invention may have substantially isotropic thermal expansion properties, due to the carbon nanotubes and/or nanofibres present in the direction perpendicular to and between two-dimensional fibre layers acting to reduce thermal expansion in that direction. Reduced expansion in this direction may also provide improved friction stability. Also, preforms for composites according to the invention may have a greater volume fraction of nanotubes and/or nanofibres in the direction perpendicular to the two-dimensional fibre layers than can be achieved in a needled preform.

The above list of advantages of the invention is not exhaustive. These and further advantages of the present invention will become apparent to the person skilled in the art.

As will become apparent, articles according to the invention have application in a wide range of fields, for example as friction discs in braking systems, especially aircraft braking systems. Other possible fields of application include electrochemical applications, e.g. fuel cells and supercapacitors, protective clothing and body armour, vehicle armour, blast containment and thermal tiles for lining nuclear fusion vessels such as the diverter in the Joint European Torus (JET).

By way of example only, certain embodiments of the invention will now be described with reference to the Figures in which:

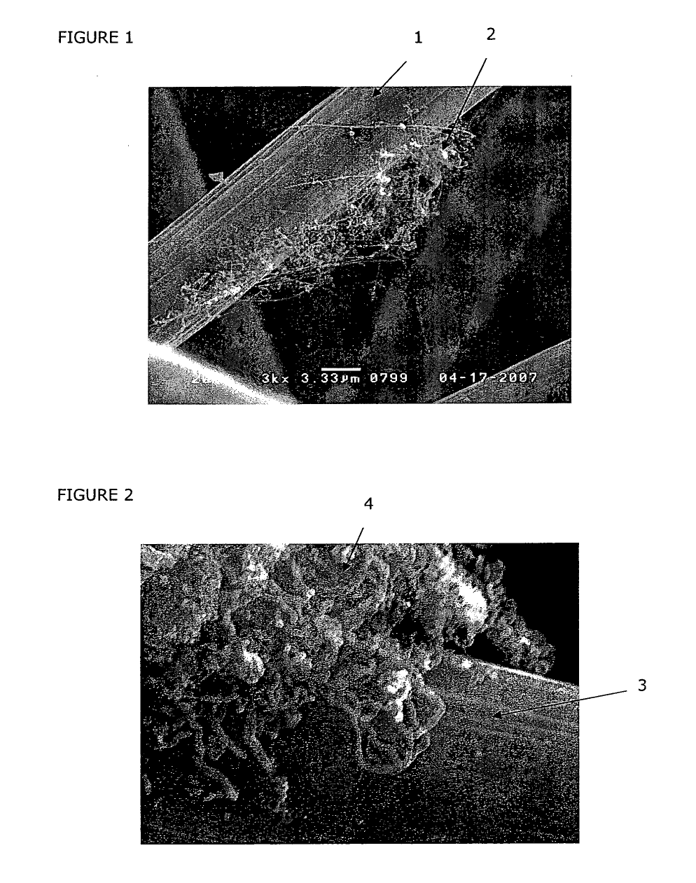

FIG. 1 is a scanning electron microscope (SEM) micrograph showing carbon nanotubes which have been formed within a carbon fibre fabric.

FIG. 2 is an SEM micrograph showing carbon nanotubes which have been formed within a carbon fibre fabric.

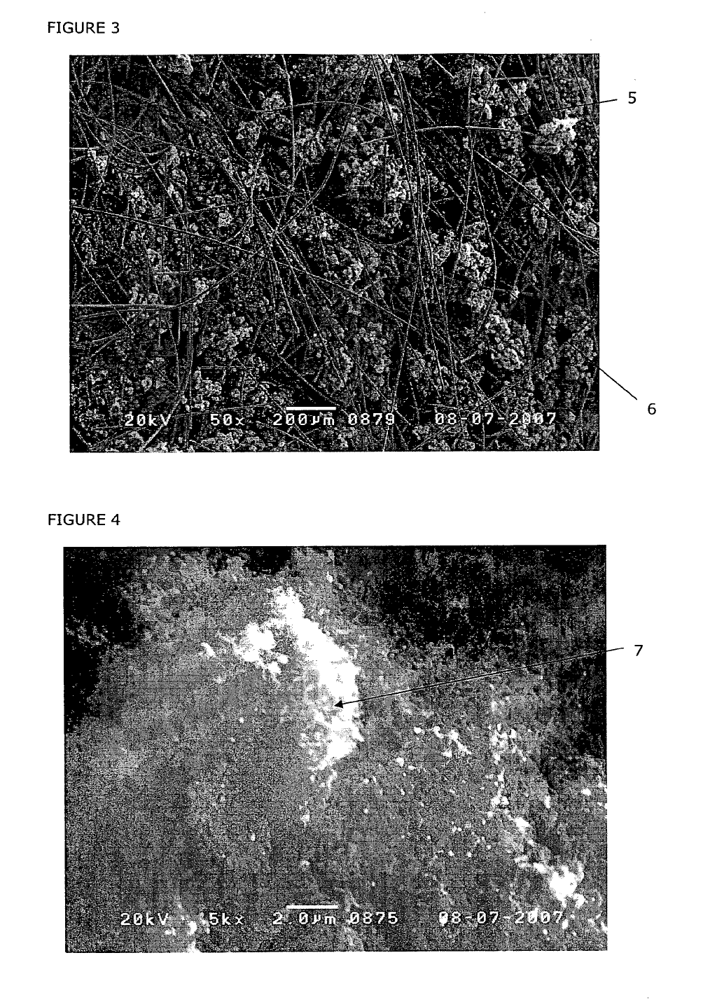

FIG. 3 is an SEM micrograph which shows the nanotubes and the carbon fibres of a fabric layer after removal from the jig following nanotube growth.

FIG. 4 is an SEM micrograph which shows a further magnified portion of FIG. 3 in which a cluster of nanotubes is present.

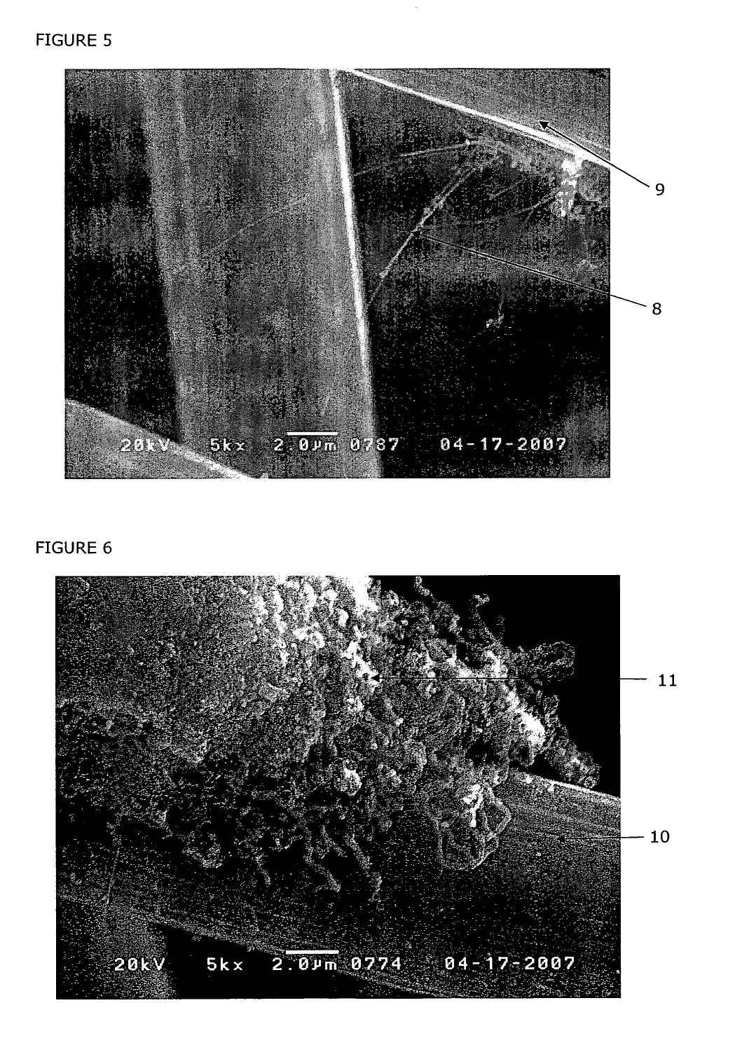

FIG. 5 is an SEM micrograph showing carbon nanotubes which have grown close to and in a direction away from the surface of a carbon fibre.

FIG. 6 is an SEM micrograph showing a carbon fibre around which has grown a cluster of nanotubes.

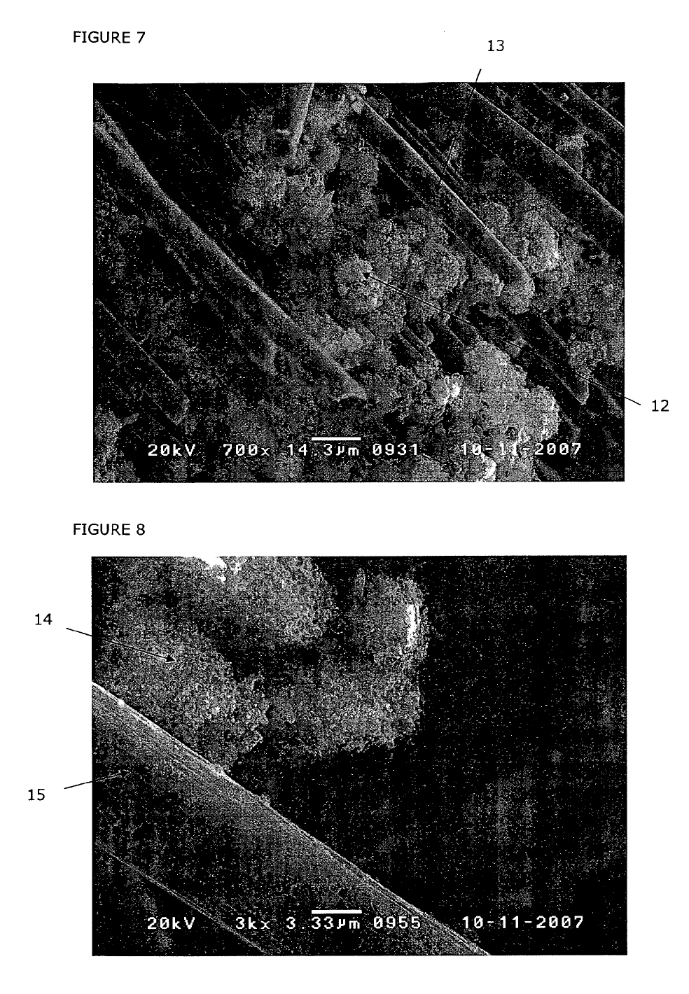

FIG. 7 is an SEM micrograph showing entangled agglomerates of carbon nanotubes and/or nanofibres which have grown in the spaces between carbon fibres.

FIG. 8 is an SEM micrograph showing a carbon fibre and an entangled agglomerate of carbon nanotubes and/or nanofibres.

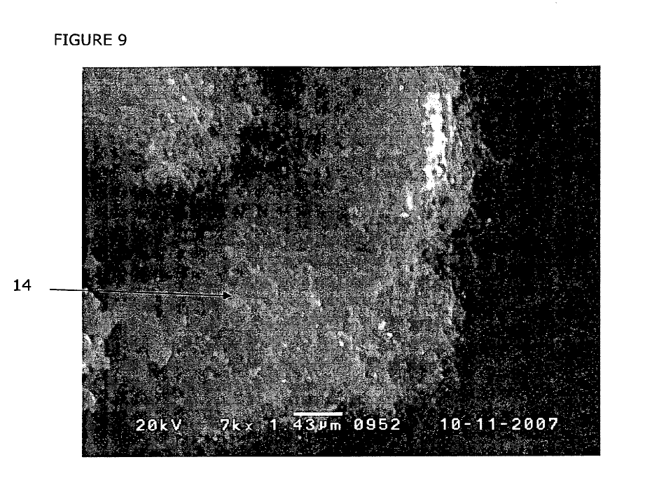

FIG. 9 is a further magnified view of the entangled agglomerate shown in FIG. 8.

In a method according to the invention, carbon nanotubes and nanofibres are formed on and/or around carbon fibres in a carbon fabric or felt using a metal catalyst and a carbon source. A suitable metal catalyst may be selected from a group including transition metals, e.g. iron, nickel, or cobalt, or any of their compounds. The carbon source may be any hydrocarbon gas, carbon monoxide, carbon dioxide, or any other carbon compound.

A solution of the metal catalyst powder in alcohol, e.g. methanol or ethanol, or other suitable solvent known in the art is used to impregnate carbon fibre fabric/felt with the metal catalyst. This impregnation process involves creating a dispersion or solution of the metal catalyst particles using an ultrasonic bath or probe or any other suitable mixer (e.g. high-speed mixer). After ultrasonic mixing of the metal catalyst particles for a period of 5-45 minutes the carbon fibre fabric or a stack of carbon fibre fabric layers in a jig is dipped into the solution and given further ultrasonic treatment for another period of 5-45 minutes.

The fabric or jig containing fabric is removed from the catalyst suspension and dried at a temperature up to 200° C., preferably a temperature between 150° C. and 200° C.

The ultrasonic mixing stages may preferably last for 10 to 40 minutes, more preferably 10 to 30 minutes.

In a method according to the invention, layers of a carbon fabric, such as the non-woven carbon fibre fabric comprising a staple layer needled to continuous fibre tows described in GB 2,012,671 are cut to the required shape, for example segments or rings for an aircraft brake disc. The layers are arranged in a stack on a first jig plate to make a disc of required thickness or fibre weight for required fibre volume when the layers are compressed to required thickness.

A second jig plate is placed on top of the stack of fibre layers. The stack is compressed between the jig plates to the required thickness for required fibre volume. Fibre volume is typically in the range 5%-50%, preferably 15-30% and more preferably 20-25%. The remaining volume comprises void space.

The carbon fabric in the jig is treated by dipping in a metal catalyst solution or a dispersion of metal catalyst powder in alcohol, which has been mixed in an ultrasonic bath for a period of 5-45 minutes as described above. The jig is left in the ultrasonic bath for a further 5-45 minutes to ensure penetration of the catalyst throughout the carbon fabric layers in the jig. The jig is then removed from the ultrasonic bath and the carbon fabric layers are allowed to dry at a temperature of up to 200° C.

Alternatively, in order to ensure an even distribution of catalyst throughout the fabric, the fabric may be treated with the metal catalyst dispersion or solution before or after cutting and prior to location of the fabric in the jig. Fabric treated in this way is preferably dried prior to being placed in the jig. Drying can be carried out in air at any suitable temperature, preferably at a temperature of between 20° C. and 200° C.

If a metal compound such as a metal nitride is used for the catalyst then the compound can be oxidised by heating in air at a temperature in the range 150° C.-300° C., preferably 200° C.-250° C. The oxide can then be reduced by heating to a temperature greater than 500° C., preferably 600° C.-650° C. in a reducing atmosphere, for example argon or nitrogen with 1%-20% hydrogen, preferably 5%-10% hydrogen for a period of between one and five hours.

Following impregnation with the catalyst, once the stack of fabric in the jig is dry the jig is placed in a suitable furnace for growth of carbon nanotubes. The jig containing the stack of fabric is placed in the furnace vessel and heated in an inert atmosphere to the required temperature for growth of carbon nanotubes or nanofibres.

Carbon nanotubes can be grown in a suitable vessel in the temperature range from room temperature to up to 1200° C. A preferred temperature range for carbon nanotube and/or nanofibre growth is 400-1200° C., more preferably 600-900° C.

Suitable inert atmospheres are well known and typically comprise nitrogen or argon, preferably argon. Examples include argon or nitrogen with 1% -20% hydrogen, preferably 5% -10% hydrogen. Preferably, the inert gas flows through the vessel during the heating cycle.

The furnace temperature is ramped up to the desired temperature for carbon nanotube and/or nanofibre growth. Once this temperature is reached the flow of inert gas is stopped and the flow of a gas that is decomposable to provide a carbon source for nanotube and/or nanofibre growth is started. The preferred gas is typically a hydrocarbon gas such as methane, natural gas or acetylene. Decomposition of the hydrocarbon gas on the catalyst particles at a temperature up to 1100° C., preferably 500° C.-1100° C., causes formation and growth of carbon nanotubes and carbon nanofibres on the catalyst particles. After a growth period of between 15 minutes and 5 hours, preferably between 30 minutes and 120 minutes, the furnace is switched off. The stack of fabric layers is allowed to cool down in an inert gas flow.

After having been loaded into the jig and compressed to the preferred fibre volume, the fibres in adjacent fabric layers may be in intimate contact. Growth of carbon nanotubes and/or nanofibres in the stack of fabric loaded into the jig is allowed to progress until nanotubes and/or nanofibres have reached a length where they can interlock with each other and with the fibres of adjacent fibre layers maintained in close contact. This interlocking of the carbon nanotubes and/or nanofibres in the direction perpendicular to the plane of the two-dimensional fibre layers acts to hold the fabric layers together resulting in benefits in composite manufacturing and in the properties of the finished composite.

The carbon nanotube growth can be in the range from 1% up to equivalent to more than 1,000% the original volume of carbon fibre.

In a composite with, for example, 20% fibre volume the maximum nanotube growth is limited to 400% of the volume of the carbon fibre, as that would then represent a fully densified composite of carbon fibre and carbon nanotubes.

Following growth, the carbon nanotubes and/or nanofibres may have a weight of from 3% to 3000% of the weight of the carbon fibres. Preferably, the carbon nanotubes and/or nanofibres may have a weight of from 3% to 300%, more preferably 3% to 150%, most preferably 3% to 100%, of the weight of the carbon fibres.

The growth of carbon nanotubes can reduce the time required to densify the carbon-carbon composite, because the growth process can be quicker than CVI densification. Thus, maximising the carbon nanotube growth can have benefits in shorter densification cycles. However, the density of carbon nanotubes and/or nanofibres (typically 1.35 gcm⁻³) is lower than for a CVI deposited carbon matrix and, therefore, a composite densified with carbon nanotubes will have a lower density than an equivalent composite densified with CVI.

A lower density can be an advantage in some applications. However, the lower density means a lower heat mass and this is a disadvantage in applications requiring high heat mass, for instance friction material discs for aircraft brake heat packs. In applications requiring a high thermal mass the balance of carbon nanotube growth and CVI should be optimised for the required composite properties and densification process time.

Carbon nanotube growth can be in the range up to the theoretical maximum for full densification of the carbon composite, for example 400% of the original carbon fibre volume in a composite containing 20% fibre volume. For friction materials and other applications requiring high thermal mass the carbon nanotube growth is preferably in the range of 5% to 200% and more preferably in the range of 10% to 100% of volume of carbon fibre.

As noted above, nanotubes and/or nanofibres typically have a density of around 1.35 gcm⁻³. This is relatively low compared with carbon fibres (approximately 1.75 gcm⁻³ for polyacrylonitrile (PAN) based fibres) and CVI carbon matrix (approximately 2.2 gcm⁻³). It is, therefore, desirable to control the volume of nanotubes in the preform structure in order to more easily achieve the final composite density required.

After growth of the carbon nanotubes and/or nanofibres is complete the preform is densified with a carbon matrix using a known densification process, preferably chemical vapour infiltration (CVI), under known conditions to give a composite having a final density preferably in the region of 1.6-1.9 gcm⁻³, say 1.6 to 1.8.

A heat treatment step, typically at temperatures greater than 2000° C. can be carried out during the manufacturing process if there is a need to eliminate the metal catalyst particles from the finished composite or to maximise the thermal conductivity of the finished composite material.

The interlocking of adjacent layers gives the potential to remove the stack of cloth layers from the jig as a preform without the need for needling operations that can have a detrimental effect on composite properties. The removal of the jig also allows a greater number of discs to be loaded into the CVI furnaces for densification of the composite with the carbon matrix. Alternatively, the preform can be left in the jig to prevent damage to the cloth layers and better maintain the integrity of the preform and the interlocking of the adjacent layers.

Benefits of nanofibre and/or nanotube interlocking between adjacent layers include improved thermal and electrical conductivity and improved mechanical properties, including interlaminar shear strength.

Also, a proportion of the nanotubes and/or nanofibres will form in the direction approximately perpendicular to the plane of the fabric layers. The proportion of nanotubes and/or nanofibres formed in the direction largely perpendicular to the plane of the fibre layers can be increased by growth in an electric field such as that found with plasma assisted CVD. As a result of interlocking between layers due to the presence of the nanotubes and/or nanofibres, the composite has a reduced thermal expansion in the perpendicular direction. Advantageously, the reduction in thermal expansion improves the stability of the friction coefficient with increasing temperature when the finished carbon-carbon composite is used in brake disc applications.

A further benefit provided when composites according to the invention are used in brake disc applications is a reduction in plucking or fibre pullout and delaminations at the friction surface during braking.

In addition, the density increase resulting from the growth of nanotubes in the fabric and between the fabric layers in the stack results in a reduction in the time required to densify the composite to finished density. Consequently, manufacture is quicker and more efficient.

### EXAMPLE

A nickel powder catalyst (99% purity, 3-7 microns in diameter) was dispersed in Industrial Methylated Spirits (IMS) at a concentration of 1 g per litre. The nickel powder dispersion in IMS was treated in an ultrasonic bath for 15 minutes to form a uniform suspension. A non-woven carbon fibre fabric comprising a staple layer needled to continuous fibre tows as described in GB 2,012,671 was cut to full annulus rings and immersed in the catalyst suspension and the ultrasonic treatment continued for a further 15 minutes in order to impregnate the nickel powder catalyst in the cloth. The cloth was then dried overnight at room temperature in a fume cupboard with a high airflow.

The dried cloth impregnated with catalyst was then assembled into a stack on a jig plate until the required volume of fibre was present. Another jig plate was then placed on top of the stack of fabric. The stack was compressed within the jig to the required thickness for 20% fibre volume using spacers of the correct height distributed around the jig. The jig was clamped to the spacer height using bolts of suitable material.

The jig was then placed in a furnace vessel for growth of carbon nanotubes. The furnace was ramped-up to a temperature of 750° C. in an inert atmosphere provided by an argon gas flow. After the desired temperature was reached hydrocarbon gas (natural gas or methane) was introduced into the furnace and the argon flow was stopped. Decomposition of the hydrocarbon gas on the catalyst particles at 750° C. caused formation and growth of carbon nanotubes and carbon nanofibres. After a growth period of 60 minutes, the furnace was switched off and allowed to cool down in an argon gas flow.

Analysis of the fabric following nanotube growth under these conditions showed the weight of nanotubes to be equivalent to 50% of the original fibre weight, giving an overall fibre volume of 33% when calculated using a nanotube density of 1.35 gcm⁻³.

In a variation on the preceding method, the inert atmosphere is provided by nitrogen or argon or a mixture of nitrogen and argon. Further, it will be appreciated that other inert gases may also be used.

In another variation, a growth period of approximately 100 minutes is employed.

FIG. 1 shows a section of carbon fibre 1 removed from the jig following nanotube 2 growth viewed with an SEM. It is clear from FIG. 1 that the nanotubes 2 are longer than the diameter of the carbon fibres 1. Thus, the nanotubes 2 are sufficiently long to reach adjacent fibres in a carbon fabric layer or to bridge the gap between carbon fabric layers.

FIG. 2 shows heavier growth of nanotubes 4 around an individual carbon fibre 3 removed from the jig following nanotube growth. The nanotubes 4 of FIG. 2 are more twisted than the generally straight nanotubes 2 of FIG. 1 and it is the twisted nature of such nanotubes 4 grown within the stack, e.g. on or between carbon fibres within a layer and between carbon fibre layers, that facilitates the interlocking of adjacent carbon fibre layers.

The stack of carbon fabric was left in the jig and loaded into a CVI furnace for the matrix densification cycle. This was carried out under conditions well known in the art. The carbon was deposited via the decomposition of natural gas at a temperature of 950° C.-1100° C. at a furnace pressure of 5-25 Torr (6.7-33.3 mbar) until a final composite density of 1.7 gcm⁻³ was reached. Typically, this takes around 200-500hours depending on a number of factors such as the geometry of the composite and furnace size.

The densified carbon-carbon composite was then heat treated at 2100° C. in order to remove the metal catalyst particles from the composite and maximise the thermal conductivity of the matrix carbon deposit.

In alternative methods the process may be repeated one or more times. For instance, the stack may be partially densified, e.g. by CVI, after which the partially-densified stack may be impregnated with a catalyst for further carbon nanotube and/or nanofibre growth.

Catalyst impregnation and subsequent carbon nanotube and/or nanofibre growth in a partially-densified stack may be carried out on one or more occasions.

The density of the partially-densified stack may be from 0.5 gcm⁻³ to 1.6 gcm⁻³, preferably from 1.2 to 1.4 gcm⁻³.

The carbon-carbon composites incorporating a preform made up of a stack of two-dimensional fibre layers having nanotubes between fibre layers have a number of advantages compared with an equivalent carbon-carbon composite without nanotubes.

The interlaminar shear stress is an area of weakness in two-dimensional carbon-carbon composites with a typical value of 1500 psi (10 MPa). Incorporating the nanotube growth between the fabric layers prior to CVI densification provides an interlocking between the fibres in adjacent layers of fabric promoting a physical bonding between the fabric layers in the stack. This has been found to result in improvements in the interlaminar shear stress in the finished composite with typical values of 3000 psi (21 MPa) for the relatively modest level of nanotube growth described in this example.

It is expected that the higher levels of nanotube growth that would result from an increased nanotube growth time would provide a carbon-carbon composite having an interlaminar shear stress approaching 4000 psi (28 MPa), which is typical of that seen in a needled carbon-carbon composite.

The physical bonding between the fabric layers allows the fabric to be removed from the jig as a preform prior to densification. The ability to remove jig plates allows for a considerable increase in the loading efficiency of the CVI furnaces.

The additional density of the fabric layers resulting from the nanotube growth results in a reduction in the CVI densification time. For the level of nanotube growth seen in this example the final density of 1.7 gcm⁻³ is reached with a reduction in CVI densification cycle time of 10%.

An additional improvement resulting from incorporating nanotubes between two-dimensional fibre layers in the preform for a carbon-carbon composite is an improvement in the thermal conductivity. The through thickness thermal conductivity (perpendicular to the fabric layers) for the composite of the example increased from approximately 50 Wm⁻¹K⁻¹ to 75 Wm⁻¹K⁻¹.

FIG. 3 shows a section viewed using an SEM of a fibre layer containing carbon fibres 5, removed from the jig following growth of nanotubes 6.

It is apparent from FIG. 3 that the nanotubes 6 have generally formed in clusters, which are distributed fairly densely throughout the network of carbon fibres 5. In FIG. 3, the clusters generally have the form of approximately spherical agglomerates, many of which have entangled themselves with their neighbours to form a network.

FIG. 4 is a magnified view of a nanotube cluster, as seen in FIG. 3. The densely packed network of intertwined nanotubes within the cluster 7 is clearly visible in FIG. 4. The intertwining, and consequent mechanical interlocking, of the nanotubes with one another and with the carbon fibres within the fibre layers may contribute to the improved properties described above.

FIG. 5 is similar to FIG. 1. It shows carbon nanotubes 8 which have grown close to a carbon fibre 9. Some of the nanotubes have grown to be substantially straight and extend away from the surface of the carbon fibre 9 in a direction almost perpendicular to the longitudinal axis of the carbon fibre 9. Thus, by growing in this direction, such carbon nanotubes may encounter and interact with nanotubes originating from the vicinity of other carbon fibres in the same or in other layers and/or with such other carbon fibres.

FIG. 6 is similar to FIG. 2. It shows a carbon fibre 10 around which has grown a cluster of nanotubes 11.

FIG. 7 shows a network 12 of carbon nanotubes and/or nanofibres formed in the spaces between carbon fibres 13. The network 12 comprises many interconnected approximately spherical entangled agglomerates of carbon nanotubes and/or nanofibres.

FIG. 8 shows a cluster 14 of many entangled carbon nanotubes and/or nanofibres formed in the vicinity of a carbon fibre 15.

FIG. 9 shows a magnified view of a portion of the cluster 14 shown in FIG. 8. The cluster 14 contains countless entangled carbon nanotubes and/or nanofibres.

As will be appreciated from the preceding description and the Figures, the nanotube network formed by the methods of the invention may comprise a plurality of interconnected agglomerates of entangled nanotubes.

Without wishing to be constrained by any particular theory it is postulated that this structure is formed in a process as set out herebelow.

When the catalyst is introduced as a powder, e.g. dispersed, dissolved or suspended in an alcohol, to the fibre layers, which may or may not be arranged as a stack, the particles of the catalyst come to be, and may also agglomerate or coalesce, at sites located within voids or pores within the fibre layers or stack.

In the furnace for carbon nanotube growth, nanotubes grow at and extend from these sites. Accordingly, three dimensional clusters of nanotubes are formed around these sites.

As the nanotubes grow and the clusters at each site expand, the clusters will begin to encroach on other clusters formed around other sites. Accordingly, as nanotube growth continues, the clusters will become ever more entangled with each other thus forming an extended network, e.g. as shown in FIG. 7.

It will also be appreciated that the methods of the present invention do not require the decomposition and/or reduction of the catalyst compound.

While the invention has been described with reference to particular examples, these are not intended to be limiting. The person skilled in the art will appreciate that any number of alterations could be made to this disclosure without departing from the scope of the invention. For example, the person skilled in the art will appreciate that the steps of the methods disclosed may be interchangeable or practised in other combinations without departing from the scope of the invention and whilst still providing preforms and/or articles in accordance with the invention.

Further, it is envisaged that other species of nanotube and/or nanofibre, e.g. boron nitride, may be used in the invention, instead of or in addition to carbon nanotubes and/or nanofibres.

In this specification, where the term nanotube is used it may represent one or more of nanotubes, nanofibres, bundles, ropes, clusters or yarns.

It is also envisaged that the layers could be made from or comprise carbon fibres, nanotubes, nanofibres, bundles, ropes, clusters or yarns.

1. A preform for a carbon-carbon composite, the preform comprising:
a plurality of layers of fibres; and
a plurality of nanostructures selected from nanotubes and nanofibres, wherein at least some of said plurality of nanostructures have proximal ends extending from a single location between and spaced from fibres of the preform.

2. A preform according to claim 1, wherein said plurality of nanostructures comprises a network for providing a mechanical interlock to at least partially hold together two or more of said plurality of layers of fibres.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A preform according to claim 1, wherein said single location is provided by a particle located in a pore defined between fibres.

43. A preform according to claim 1, wherein said plurality of layers of fibres each define a fibre-containing plane, wherein said nanostructures include carbon nanotubes and at least some of said carbon nanotubes are preferentially oriented in directions out of said fibre-containing plane of at least one fibre layer.

44. A preform for a carbon-carbon composite comprising:
a consolidated stack of two or more two-dimensional fibre layers having between the layers a nanostructure selected from carbon nanotube networks and nanofibre networks, wherein said nanostructure provides a mechanical interlock to at least partially hold together a first fibre layer of the said consolidated stack and a second layer of said consolidated stack.

45. A preform for a carbon-carbon composite comprising:
a stack of two or more two-dimensional fibre layers having carbon nanotubes present between layers in the stack, wherein said carbon nanotubes form a network which consolidates the preform.

46. A preform for a carbon-carbon composite comprising:
a first component and a second component, wherein said first component comprises a stack of two or more two-dimensional fibre layers and said second component comprises a nanostructure selected from a network of entangled nanotubes and a network of entangled nanofibres, wherein said second component is present within voids and pores within said first component without being chemically bonded to said first component.

47. A method of manufacture of a preform for a carbon-carbon composite, the method comprising the steps of:
providing a sheet comprising a two-dimensional fibre layer;
cutting the sheet into appropriately sized portions;
arranging the portions into a stack to provide at least a pair of two-dimensional fibre layers;
compressing the stack to a preferred fibre volume; and
forming carbon nanotubes within the stack to at least partially consolidate the layers either before or after said compressing step.

48. A method according to claim 47, further comprising providing a source of carbon for growing carbon nanotubes.

49. A method according to claim 47, further comprising promoting the formation of the carbon nanotubes using a metal catalyst.

50. A method according to claim 47, further comprising impregnating one or more of the sheet, the portions or the stack with a metal catalyst.

51. A method according to claim 47, wherein the fibre volume after compression is between 5% and 50%.

52. A method according to claim 47, wherein nanotube growth is allowed to take place for a period of between 15 minutes and 5 hours.

53. A method according to claim 47, further comprising subjecting the stack to an electric field.

54. A method of manufacture of a preform for a carbon-carbon composite, the method comprising the steps of:
providing an unconsolidated stack of at least a pair of two-dimensional fibre layers; and
forming a nanostructure selected from carbon nanotubes and carbon nanofibres, whereby said nanostructure consolidates the preform.

55. A method of making a brake disc for an aircraft comprising a carbon-carbon composite, the method comprising the steps of:
dispersing catalyst particles within a three-dimensional structure; and
forming nanotubes at and extending from said particles.
